(19) United States
(12) Patent Application Publication
(10) Pub. No.: US 2025/0384473 A1
(43) Pub. Date: Dec. 18, 2025

(54) PROGRESSIVE DECISIONING OF BEHAVIORAL RISK BY DYNAMICALLY ANALYZING AND SYNTHESIZING BEHAVIORAL FRAUD PATTERN

(71) Applicant: eBay Inc., San Jose, CA (US)

(72) Inventors: Tanshi SHARMA, San Jose, CA (US); Igor KOLOKOLCHYKOV, San Jose, CA (US); Dyutimoy SARKAR, San Jose, CA (US); Rongting CHEN, San Jose, CA (US); Hari Narayanan RANGARAJAN, San Jose, CA (US)

(21) Appl. No.: 18/747,145

(22) Filed: Jun. 18, 2024

(51) Int. Cl. G06Q 30/0601; G06Q 20/40; H04L 67/50

(52) U.S. Cl. CPC G06Q 30/0609; G06Q 20/40; H04L 67/535

(57) ABSTRACT

Some aspects of the present technology relate to technologies for progressive decisioning of behavioral risk by dynamically analyzing and synthesizing behavioral fraud pattern. In accordance with some configurations, a signature comprising time series data corresponding to a user of an online transaction platform is received at various checkpoints in a user workflow. These signatures are stored in a knowledge graph. Upon receiving a search query from a business user for a combination of signatures indicative of fraud, the search query is converted, without human intervention, into graph traversal logic of the knowledge graph. The knowledge graph is traversed, in real-time, utilizing the graph traversal logic. Based on the traversing, the user workflow can be dynamically modified to prevent fraudulent activity.

### BACKGROUND

In recent years, financial frauds using online transaction platforms (e.g., e-commerce and other systems that support online transactions) have attracted widespread attention. As the number of online transactions using such platforms increases, the risk of transaction fraud has also escalated. These fraudulent activities may disrupt economic stability, increase living costs, cause societal incident, and reduce consumer trust in online transaction platforms.

For example, in e-commerce platforms, users perform a variety of activities prior to committing fraud. Typically, there are one or more signatures corresponding to each activity that may be indicative of fraud. However, one or a few of these signatures may not be enough to define a policy deterministically to confirm a fraud pattern or signature. Since the consequences of fraudulent activities in online transaction platforms are devastating, developing methods and technologies to detect and identify frauds is of great importance.

### SUMMARY

Some aspects of the present technology relate to, among other things, progressive decisioning of behavioral risk by dynamically analyzing and synthesizing behavioral fraud pattern. In accordance with some configurations, a signature comprising time series data corresponding to a user of an online transaction platform is received at various checkpoints in a user workflow. These signatures are stored in a knowledge graph. Upon receiving a search query from a business user for a combination of signatures indicative of fraud, the search query is converted, without human intervention, into graph traversal logic of the knowledge graph. The knowledge graph is traversed, in real-time, utilizing the graph traversal logic. Based on the traversing, the user workflow can be dynamically modified.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system, in accordance with some implementations of the present disclosure;

FIG. 2 is a diagram showing an example of progressive decisioning of behavioral risk, in accordance with some implementations of the present disclosure;

FIG. 3 is an example of a time series view of the data corresponding to various checkpoints, in accordance with some implementations of the present disclosure;

FIG. 4 is a diagram of an example network architecture for progressive decisioning of behavioral risk by dynamically analyzing and synthesizing behavioral fraud pattern, in accordance with some implementations of the present disclosure;

FIG. 5 is a flow diagram showing a method for progressive decisioning of behavioral risk by dynamically analyzing and synthesizing behavioral fraud pattern, in accordance with some implementations of the present disclosure; and

FIG. 6 is a block diagram of an exemplary computing environment suitable for use in implementations of the present disclosure.

### DETAILED DESCRIPTION

The continued growth of online transaction platforms (including, for instance, e-commerce and other systems that support online transactions) presents a particular challenge for identifying and combating fraudulent activity at a level that did not exist before the advent of such platforms. Conventional fraud detection approaches for online transaction platforms utilize various architectures that struggle with efficiency. For example, some approaches store vast amounts of data corresponding to user interactions in a database. Though these approaches may be effective in identifying fraud, they are unable to do so at a speed and scale required by online transaction platforms. The resulting latency makes these approaches impractical for real-time fraud detection. Moreover, they are unable to detect patterns that do not occur in a linear fashion.

In another example, some approaches leverage complex event processing in which a distributed network of computation resources continuously listen to user activity, compute signatures, and store them in memory. In this approach, the logic to analyze a combination of signatures would need to be set up in a topology (e.g., sequence) to confirm a specific combination of signatures is satisfied. However, if another combination of signatures needs to be analyzed, another topology needs to be set up (or a sub part of an existing topology needs to be changed). This may be problematic because the combination of signatures is unbounded and can change dynamically as the behavioral fraud changes. In addition, user activities can occur at irregular intervals where the time interval between two activities could be days apart. Storing data for all user in memory for long period of time is impractical, costly, and not scalable for real-world applications.

Aspects of the technology described herein improve the ability to detect fraudulent activity on online transaction platforms in real-time and at scale by dynamically analyzing and synthesizing behavioral fraud pattern. The techniques described herein have been demonstrated to provide marked improvement in fraud detection performance over previous approaches and do so at scale and support any number of combinations of signatures or any volume of traffic.

In accordance with some aspects of the technology described herein, business rules can be leveraged to dynamically search for signals that are indicative of some risk when a user performs an activity. Each of the risk indicators can be tracked for users and stored as an immutable record sorted by time sequence. Users who are actioned because of fraud can be identified and association mining can be applied to the record. Once a pattern is identified, a business user can express the pattern as a domain specific language (DSL). The DSL is automatically converted (i.e., without human intervention) into graph traversal logic. When a user enters a particular workflow, time series user activity data is collected at various checkpoints and is stored in memory in a knowledge graph. The graph traversal logic is utilized to search the data and friction can be applied to the workflow (i.e., the workflow is dynamically modified to prevent the fraud) when fraud is detected. In some aspects, some aggregation may be performed in memory (e.g., count of activities or time distance between activities).

Aspects of the technology described herein provide a number of improvements over existing technologies. For instance, the problem of scale with different combinations of signatures and traffic volume are overcome by organizing user activity data between two timestamps as a knowledge graph in memory. In this way, the size of the data between the two timestamps is concise enough to fetch in one read. The combination of signatures provided as the search query enables the graph to be navigated by testing adjacency relations. As a result, signatures specified in combination can be matched in memory. Given X combinational searches, the complexity is, at most, a polynomial if run on a single thread. A multi-threaded combination search (i.e., parallel processing) reduces any potential degradation from linear time.

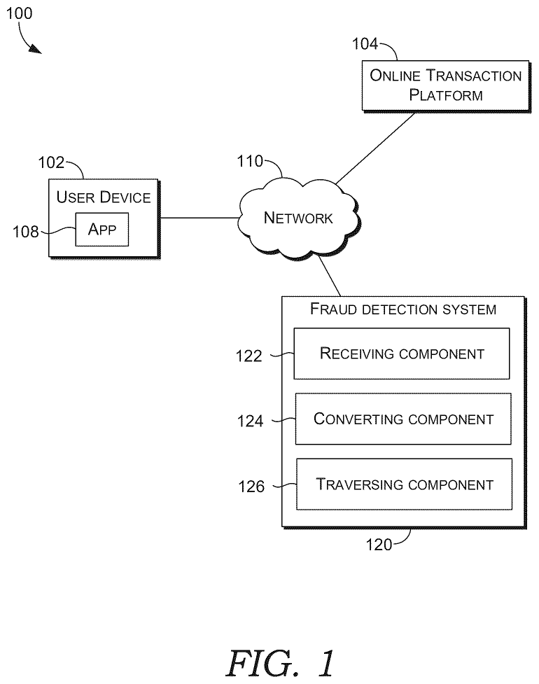

With reference now to the drawings, FIG. 1 is a block diagram illustrating an exemplary system 100 for progressive decisioning of behavioral risk by dynamically analyzing and synthesizing behavioral fraud pattern, in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

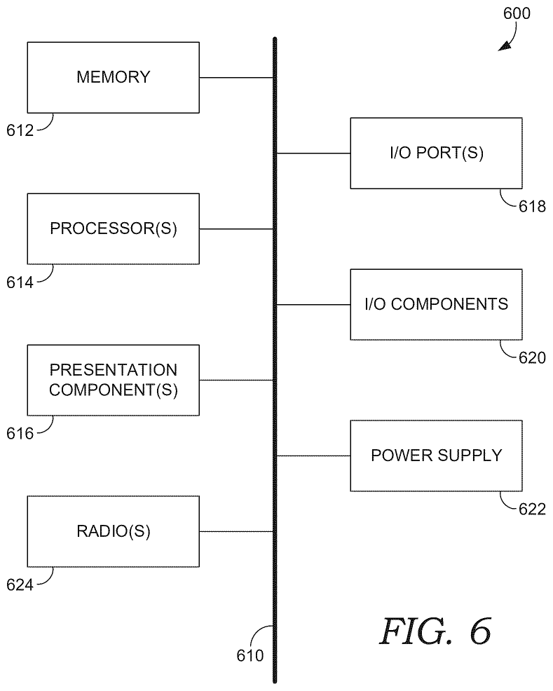

The system 100 is an example of a suitable architecture for implementing certain aspects of the present disclosure. Among other components not shown, the system 100 includes a user device 102, an online transaction platform 104, and a fraud detection system 120. Each of the user device 102, the online transaction platform 104, and the fraud detection system 120 shown in FIG. 1 can comprise one or more computer devices, such as the computing device 600 of FIG. 6, discussed below. As shown in FIG. 1, the user device 102, the online transaction platform 104, and the fraud detection system 120 can communicate via a network 110, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the online transaction platform 104 and the fraud detection system 120 could each be provided by multiple server devices collectively providing the functionality of the online transaction platform 104 and the fraud detection system 120 as described herein. Additionally, other components not shown may also be included within the network environment.

The user device 102 can be a client device on the client-side of operating environment 100, while the online transaction platform 104 and the fraud detection system 120 can be on the server-side of operating environment 100. The online transaction platform 104 and/or the fraud detection system 120 can each comprise server-side software designed to work in conjunction with client-side software on the user device 102 so as to implement any combination of the features and functionalities discussed in the present disclosure. For instance, the user device 102 can include an application 108 for interacting with the online transaction platform 104 and/or the fraud detection system 120. The application 108 can be, for instance, a web browser or a dedicated application for providing functions, such as interacting with the online transaction platform 104 and/or the fraud detection system 120. This division of operating environment 100 is provided to illustrate one example of a suitable environment, and there is no requirement for each implementation that any combination of the online transaction platform 104 and the fraud detection system 120 remain as separate entities. For instance, in some aspects, the fraud detection system 120 is a part of the online transaction platform 104. While the operating environment 100 illustrates a configuration in a networked environment with a separate user device, online transaction platform, and fraud detection system, it should be understood that other configurations can be employed in which aspects of the various components are combined.

The user device 102 may comprise any type of computing device capable of use by a user. For example, in one aspect, a user device may be the type of computing device 600 described in relation to FIG. 6 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the online transaction platform 104 and/or the fraud detection system 120 via the user device 102.

The online transaction platform 104 can be implemented using one or more server devices, one or more platforms with corresponding application programming interfaces, cloud infrastructure, and the like. The online transaction platform 104 generally comprises any computer-based system that facilitates electronic transactions over the network 110 via user devices, such as the user device 102. In some aspects, the online transaction platform 104 comprises a listing platform (e.g., an e-commerce platform) that generally provides, to the user device 102, item listings describing items (physical or digital) available for purchase, rent, streaming, download, etc., and facilitates electronic purchase transactions for items. In other aspects, the online transaction platform 104 comprises a payment platform that facilitates electronic payment transactions between two accounts. In still further aspects, the online transaction platform 104 comprises a banking platform that facilitates the electronic transfer of money between accounts.

As described in further detail below, the fraud detection system 120 progressive decisioning of behavioral risk by dynamically analyzing and synthesizing behavioral fraud pattern between a user device, such as the user device 102, and an online transaction platform, such as the online transaction platform 104. The components of the fraud detection system 120 may be in addition to other components that provide further additional functions beyond the features described herein. The fraud detection system 120 can be implemented using one or more server devices, one or more platforms with corresponding application programming interfaces, cloud infrastructure, and the like. While the fraud detection system 120 is shown separate from the online transaction platform 104 and the user device 102 in the configuration of FIG. 1, it should be understood that in other configurations, some of the functions of the fraud detection system 120 can be provided on the online transaction platform 104 and/or the user device.

In some aspects, the functions performed by components of the fraud detection system 120 are associated with one or more applications, services, or routines. In particular, such applications, services, or routines may operate on one or more user devices, servers, may be distributed across one or more user devices and servers, or be implemented in the cloud. Moreover, in some aspects, these components of the fraud detection system 120 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The fraud detection system 120 analyzes time series data corresponding to a user at various checkpoints to determine whether the time series data is indicative of fraudulent activity on the online transaction platform 104. The time series data generally comprises any information regarding user interaction, via the user device 102 (in some cases, using the application 108), with the online transaction platform 104. In some configurations, the online transaction platform 104 is a website or web application that provides one or more pages (i.e., user interfaces) that are presented via the user device 102 and allow for user interaction (for a business user).

The fraud detection system 120 includes a receiving component 122, a converting component 124, and a traversing component 126. The receiving component 122 generally receives a signature at various checkpoints in a user workflow. The signature comprises time series data corresponding to the user. The time series data includes any user interactions that occur with the online transaction platform 104. For example, the time series data may include activity name, user identifier, device identifier, session identifier, geolocation, set of signatures, and the like.

The receiving component 122 stores the signature comprising the time series data in a knowledge graph. An activity may be represented by a vertex of the knowledge graph and each activity performed immediately before and after the activity may be represented by different vertices of the knowledge graph, each connected to the vertex by an edge. The knowledge graph may be traversed by each node in an order indicated by the edge.

The converting component 124 generally converts a search query for a combination of signatures indicative of fraud into graph traversal logic of the knowledge graph. For example, a business user may identify a combination of signatures indicated of fraud that is defined by a deterministic pattern. The pattern may be specified by a relation such as “preceded-by” or “followed-by” with qualifiers describing the activity. The relation between activities may be expressed using domain specific language (DSL). In this way, the business user does not need to possess knowledge about keys and the combination of signatures can be expressed without any change in code; rather, it is driven by configuration. The converting component 124 reads the DSL query and decomposes it into a format conducive of graph traversal.

The traversing component 126 utilizes the graph traversal logic to traverse the knowledge graph, at runtime of the user workflow. Based on the traversing, the user workflow may be dynamically modified. For example, if fraud is detected, the traversing component may introduce friction into the workflow to prevent the fraud from being completed. For example, an account associated with the fraud may be frozen, the account associated with the fraud may be closed, and/or a transaction or other activity (e.g., user, location, address, device, or other type of verification) may be blocked. In some instances, a notification can alternatively or additionally be provided to an administrator associated with the online transaction platform 104.

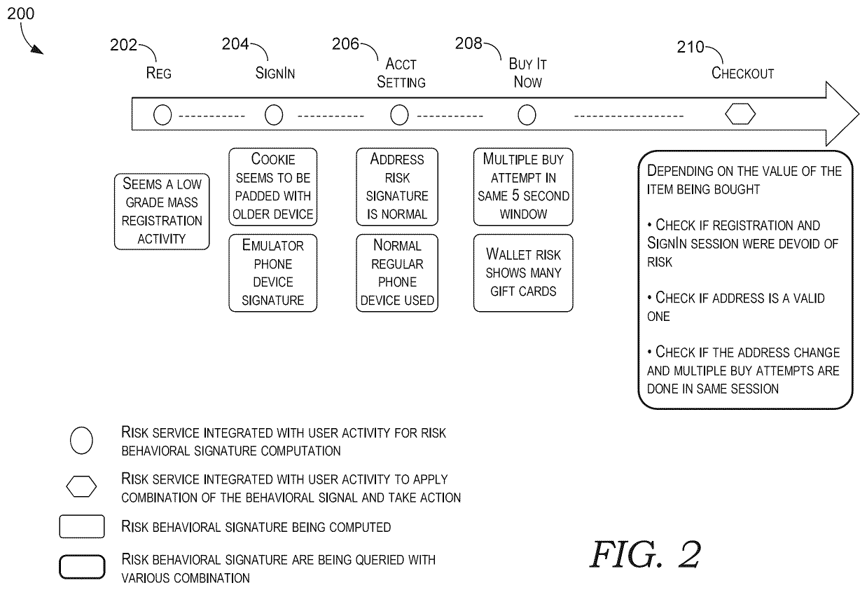

FIG. 2 depicts a diagram 200 of an example of progressive decisioining of behavioral risk, in accordance with some aspects of the technology described herein. As shown, at various checkpoints, the fraud detection system is integrated with user activity 202, 204, 206, 208, 210 on the online transaction platform to perform progressive decisioning of behavioral risk. An online transaction platform may have users that exhibit normal activities before committing fraud. There may be one or more signatures indicating risky behavior at each user activity. However, a single signature (or even a few signatures) may not be enough to define a policy deterministically to confirm a fraud pattern or signature. But, a fraud pattern can be confirmed by applying various combinational logic on these signatures to determine a fraud or indicate a gap in the risk detection.

To illustrate, at user registration 202, the fraud detection system may receive a signature that indicates a low grade mass registration activity. At sign in 204, the fraud detection system may receive a signature that indicates a cookie was embedded with an older device and that an emulator phone device is being used. If the user changes an account setting 206, the fraud detection system may receive a signature that indicates an address change is normal and an expected phone device is being used. If the user attempt to buy an item 208, the fraud detection system may receive a signature that indicates multiple purchase attempts were attempted in the same five second window and the wallet risk reveal a large number of gift cards are stored. At checkout 210, the fraud detection system is triggered to analyze the fraud pattern based on the received signatures. For example, the fraud detection system may, depending on the value of the item being purchased, check if registration and sign in were devoid of risk, check if the address is valid, and/or check if the address change and multiple purchase attempts were done in the same session. In other words, the fraud detection system analyzes various combinations of the signatures to determine a fraud.

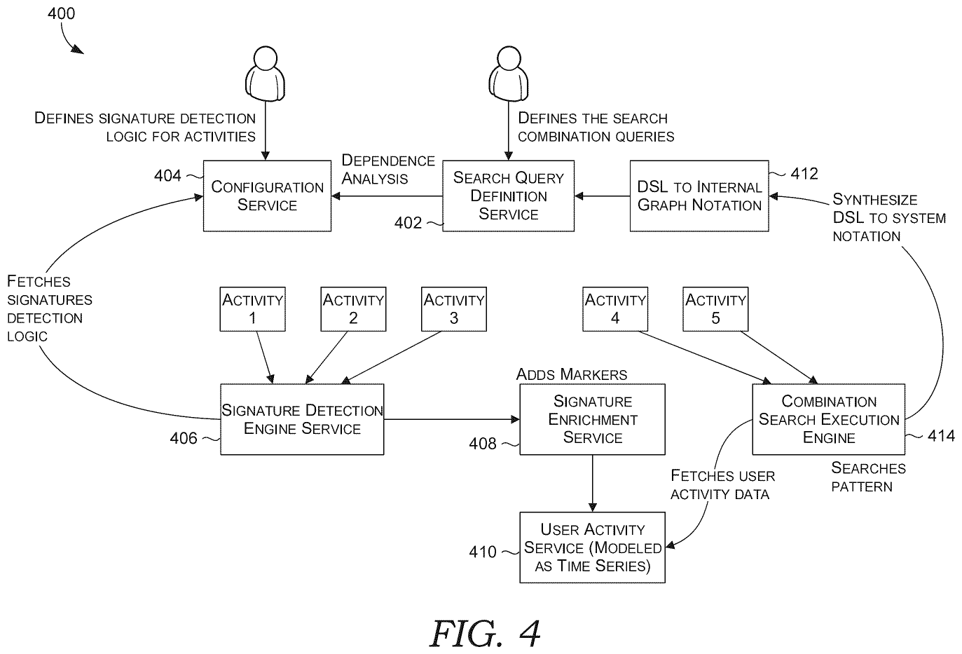

FIG. 4 depicts a diagram 400 of an example network architecture for progressive decisioning of behavioral risk by dynamically analyzing and synthesizing behavioral fraud pattern, in accordance with some implementations of the present disclosure.

Search query definition service 402 provides a business user an interface to define the search query as a combination of signatures. In aspects, a business user may identify one or more confirmed fraudulent users (buyers or sellers). Association mining on time series data can help detect patterns corresponding to the one or more confirmed fraudulent users. If a pattern is detected, the business user can create a query using DSL.

For example, the combination of the signatures resulting in a deterministic pattern can be specified by a relation defining “preceded-by” and “followed-by” with qualifiers describing the signature. This type of relational query is achieved using DSL to express the relation between activities. By way of example, the DSL query may be expressed as:

```
  Search Activities in ‘last X hours
  where {
    Activity A2 with (signature 1 : value1) preceded-by activity A1 with
(signature 2: value2)
    AND
    Activity A2 with (signature 1 : value1) followed-by activity A1 with
(signature 5: value5)
  }
```

In this expression: “Search Activities” is a search directive to the system and “Last X hours” is time window to look back. The brackets “{}” define a combination of signature being investigated. “Preceded-by” and “Followed-by” define the direction of navigation, “Activity” is used to specify the user activity, “With” used with a parenthetical “( )” defines qualifiers for activities, and “AND” or “OR” are logical operators to create combinations between activities and signatures.

Configuration service 404 maintains the business logic to define risk signatures against user activities. This enables the business user to express DSL queries for risk signatures that are known and defined for a particular user activity (buyer or seller). Once the DSL queries are created, signature detection engine service 406 receives the queries and compute the corresponding signature. In some aspects, signature enrichment service 408 adds additional markers to the signature. For example, signature enrichment service 408 enables business logic to add markers including geolocation, type of device, and/or browser used that may be relevant to the fraud corresponding to the activity.

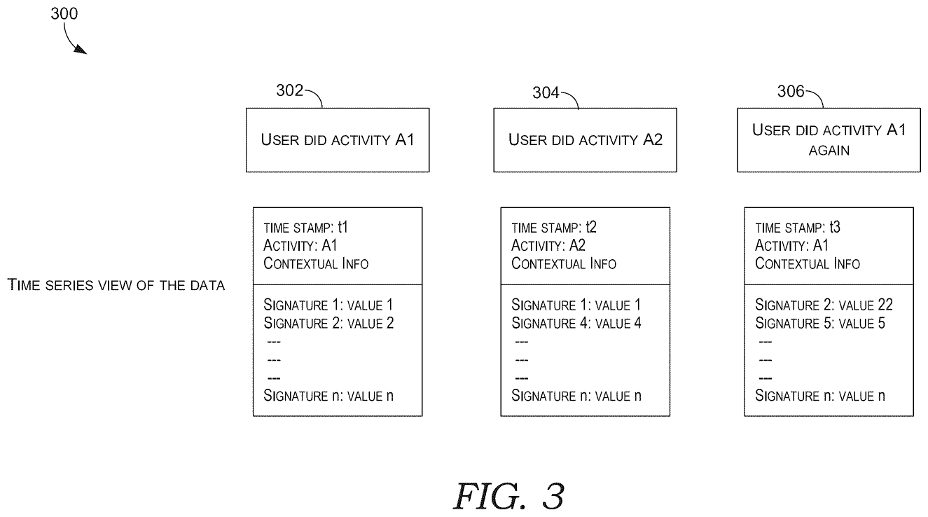

User activity service 410 persists data of a user activity, modeled as a time series. For example, referring now to FIG. 3, an example of a time series view of the data corresponding to various checkpoints is illustrated, in accordance with some implementations of the present disclosure is illustrated, in accordance with some aspects of the technology described herein. As shown, user activity service 410 may collect signatures comprising time series data at various checkpoints. For example, if the user performs activity A1 at 302, A2 at 304, and A3 at 306, various signatures may be collected. The signatures may be computed by business need and the computed signature may be pushed over a messaging queue as an event. The event payload may include details about the activity name, a user identifier, a device identifier, a session identifier, a geolocation, and a set of signatures. The event may be pushed to a time series database that maintains the data in a time series fashion.

Referring back to FIG. 4, DSL to internal graph notation 412 reads DSL queries and decomposes the DSL queries into a format conducive of graph traversal. Additionally for queries where aggregation on an activity count is specified, DSL to internal graph notation 412 identifies hints corresponding to appropriate aggregation functions for combination search execution engine 414 to use (e.g., sum, test of presence, or absence of activity).

Combination search execution engine 414 fetches the user activity data and search queries along with hints for appropriate aggregation functions. The combination search execution engine 414 performs graph traversal as specified in the query. Moreover, the combination search execution engine 414 tests if a logical criteria fails or passes during graph traversal and enables the combination search execution engine 414 to determine if the combination of risk signatures as defined by the query matches with user activity, in real-time and, in some aspects, using parallel processing.

In practice, and during runtime, for a particular user in question, the fraud detection system queries the time series database between NOW and NOW-X hours. Accordingly, the data for the user is fetched by going back X hours. Next, the data is arranged system from the time series as a graph in time sorted in a topological order with activities as vertices and qualifiers for activities as adjacency relations with other activities. The problem of scale with different combinations of signature and traffic volume is overcome because between two timestamps, the data is organized as a graph in memory. Moreover, the size of the data between two timestamps is concise enough to fetch in one read operation.

Since the combination of signatures is provided as a search query, the graph can be navigated by testing the adjacency relation and to match the combination of signatures in memory. For a given combination of signatures, the graph traversal by visiting all the activity vertices is an order of G(V+E). Since the activities form a connected graph and not a complete graph, G(V+E) can be considered a linear order. If there are ‘X’ combinational searches, then at most, the complexity is a polynomial if run on a single thread. In a practical scenario, parallel processing (e.g., multi-threaded combinational search) is utilized and there is no degradation from linear time. In various aspects, a search for signatures defined in some combinatorial sequence and/or a search for a signature with some aggregated information can be accomplished. Example searches may include:

```
  Example 1:
  Search Activities in ‘last X hours’
  where {
    Activity A2 Occurred (2 times) preceded-by activity A1 with
(signature 2: value2)
  }
  Example 2:
  Search Activities in ‘last X hours’
  where {
    Timestamp difference between (Activity A2, Activity A1) within ‘30’
minutes
  }
  Example 3:
  Search Activities in ‘last X hours’
  where {
    Activity A2 Occurred (2 times) with (signature 1: [value1, value7,
    value9]
  }
```

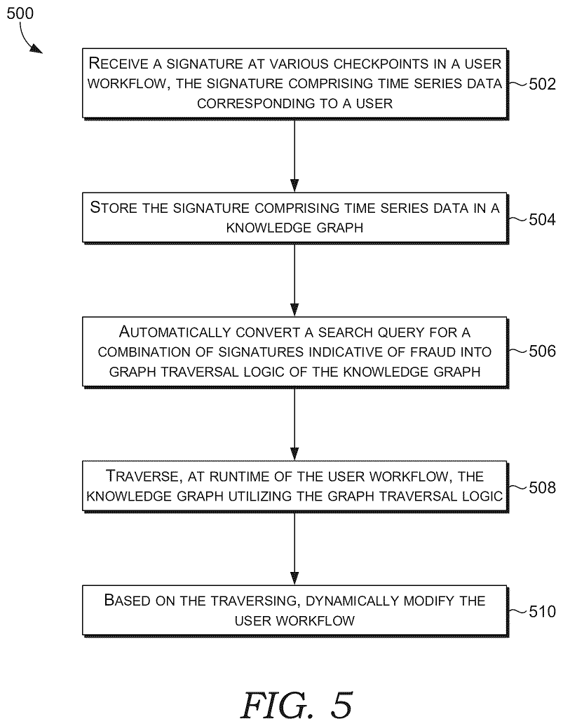

With reference now to FIG. 5, a flow diagram is provided that illustrates a method 500 for progressive decisioning of behavioral risk by dynamically analyzing and synthesizing behavioral fraud pattern, in accordance with some implementations of the present disclosure. The method 500 can be performed, for instance, by the fraud detection system 120 of FIG. 1. Each block of the method 500 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, a signature is received at various checkpoints in a user workflow. The signature comprises time series data corresponding to a user. In some aspects, the checkpoints comprise: user registration, user sign in, change in shipping address, change in email address, change in user device, or checkout. Additionally, a geolocation of a user device corresponding to the user workflow, a device type of the user device, and browser or application information corresponding to the user workflow may be aggregated with the time series data.

At block 504, the signature comprising time series data is stored in a knowledge graph. In some aspects, the signatures of risk indicators from the knowledge graph storing time series data corresponding to fraudulent users may be received. In some aspects, a business user dynamically specifies, at a user interface, the checkpoint in the user workflow to check for potential fraud. A search query for signatures of risk indicators may be received at the user interface. The signatures of risk indicators may comprise a combination of signatures. At block 506, a search query for a combination of signatures indicative of fraud is converted, without human intervention, into graph traversal logic of the knowledge graph. In this way, the business user can dynamically search for the combination of signatures leading up to the checkpoint in the user workflow.

At block 508, at runtime of the user workflow, the knowledge graph is traversed utilizing the graph traversal logic. The graph traversal logic attempts to match, in real-time (and through parallel processing when multiple signatures are being searched for) the signatures of risk indicators with the knowledge graph corresponding to time series data of the user. In aspects, the knowledge graph (or a portion thereof) is stored in memory for quick access and traversal. At block 510, the user workflow is dynamically modified, based on the traversing. In various aspects, the modifications may include friction to deter or prevent fraud such as: freezing an account associated with the fraud, closing the account associated with the fraud, preventing or blocking a transaction or activity, or requiring verification (e.g., user, location, address, device, or other type of verification).

Having described implementations of the present disclosure, an exemplary operating environment in which embodiments of the present technology can be implemented is described below in order to provide a general context for various aspects of the present disclosure. Referring initially to FIG. 6 in particular, an exemplary operating environment for implementing embodiments of the present technology is shown and designated generally as computing device 600. Computing device 600 is but one example of a suitable computing environment and is not intended to suggest any limitation as to the scope of use or functionality of the technology. Neither should the computing device 600 be interpreted as having any dependency or requirement relating to any one or combination of components illustrated.

The technology can be described in the general context of computer code or machine-usable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 6, computing device 600 includes bus 610 that directly or indirectly couples the following devices: memory 612, one or more processors 614, one or more presentation components 616, input/output (I/O) ports 618, input/output components 620, and illustrative power supply 622. Bus 610 represents what can be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer storage media in the form of volatile and/or nonvolatile memory. The memory can be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which can be built in. Illustrative components include a microphone, joystick, game pad, satellite dish, scanner, printer, wireless device, etc. The I/O components 620 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 600. The computing device 600 can be equipped with depth cameras, such as, stereoscopic camera systems, infrared camera systems, RGB camera systems, and combinations of these for gesture detection and recognition. Additionally, the computing device 600 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-usable instructions that, when used by one or more computing devices, cause the one or more computing devices to perform operations, the operations comprising:
receiving a signature at various checkpoints in a user workflow, the signature comprising time series data corresponding to a user;
storing the signature comprising the time series data in a knowledge graph;
converting, without human intervention, a search query for a combination of signatures indicative of fraud into graph traversal logic of the knowledge graph;
traversing, at runtime of the user workflow, the knowledge graph utilizing the graph traversal logic; and
based on the traversing, dynamically modifying the user workflow to prevent fraudulent activity.

2. The one or more computer storage media of claim 1, further comprising, receiving, the signatures of risk indicators from a knowledge graph storing time series data corresponding to fraudulent users.

3. The one or more computer storage media of claim 2, further comprising, receiving, at a user interface, a search query for signatures of risk indicators, wherein the signatures of risk indicators comprise a combination of signatures.

4. The one or more computer storage media of claim 1, further comprising, aggregating a geolocation of a user device corresponding to the user workflow, a device type of the user device, and browser or application information corresponding to the user workflow.

5. The one or more computer storage media of claim 1, further comprising, enabling, at a user interface, a business user to dynamically specify the checkpoint in the user workflow.

6. The one or more computer storage media of claim 1, further comprising, enabling, at a user interface, a business user to dynamically search for the combination of signatures leading up to the checkpoint in the user workflow.

7. The one or more computer-storage media of claim 1, wherein the checkpoint comprises: user registration, user sign in, change in shipping address, change in email address, change in user device, or checkout.

8. A computer-implemented method comprising:
receiving a signature at various checkpoints in a user workflow, the signature comprising time series data corresponding to a user;
storing the signature comprising the time series data in a knowledge graph;
converting, without human intervention, a search query for a combination of signatures indicative of fraud into graph traversal logic of the knowledge graph;
traversing, at runtime of the user workflow, the knowledge graph utilizing the graph traversal logic; and
based on the traversing, dynamically modifying the user workflow to prevent fraudulent activity.

9. The computer-implemented method of claim 8, further comprising, receiving, the signatures of risk indicators from a knowledge graph storing time series data corresponding to fraudulent users.

10. The computer-implemented method of claim 9, further comprising, receiving, at a user interface, a search query for signatures of risk indicators, wherein the signatures of risk indicators comprise a combination of signatures.

11. The computer-implemented method of claim 8, further comprising, aggregating a geolocation of a user device corresponding to the user workflow, a device type of the user device, and browser or application information corresponding to the user workflow.

12. The computer-implemented method of claim 8, further comprising, enabling, at a user interface, a business user to dynamically specify the checkpoint in the user workflow.

13. The computer-implemented method of claim 8, further comprising, enabling, at a user interface, a business user to dynamically search for the combination of signatures leading up to the checkpoint in the user workflow.

14. The computer-implemented method of claim 8, wherein the checkpoint comprises: user registration, user sign in, change in shipping address, change in email address, change in user device, or checkout.

15. A computer system comprising:
one or more processors; and
one or more computer storage medium storing computer-usable instructions that, when used by the one or more processors, causes the computer system to perform operations comprising:
receiving a signature at various checkpoints in a user workflow, the signature comprising time series data corresponding to a user;
storing the signature comprising the time series data in a knowledge graph;
converting, without human intervention, a search query for a combination of signatures indicative of fraud into graph traversal logic of the knowledge graph;
traversing, at runtime of the user workflow, the knowledge graph utilizing the graph traversal logic; and
based on the traversing, dynamically modifying the user workflow to prevent fraudulent activity.

16. The computer system of claim 15, further comprising, receiving, the signatures of risk indicators from a knowledge graph storing time series data corresponding to fraudulent users.

17. The computer system of claim 15, further comprising, receiving, at a user interface, a search query for signatures of risk indicators, wherein the signatures of risk indicators comprise a combination of signatures.

18. The computer system of claim 15, further comprising, aggregating a geolocation of a user device corresponding to the user workflow, a device type of the user device, and browser or application information corresponding to the user workflow.

19. The computer system of claim 16, further comprising:
enabling, at a user interface, a business user to dynamically specify the checkpoint in the user workflow; and
enabling, at the user interface, the business user to dynamically search for the combination of signatures leading up to the checkpoint in the user workflow.

20. The computer system of claim 15, wherein the checkpoint comprises: user registration, user sign in, change in shipping address, change in email address, change in user device, or checkout.
